(19) United States
(12) Patent Application Publication
(10) Pub. No.: US 2006/0083235 A1
(43) Pub. Date: Apr. 20, 2006

(54) Channel navigation method of digital broadcast and digital broadcast receiver to be applied to the same

(75) Inventors: Kyung-chul Nam, Suwon-si (KR); Eun-kyung Kang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/228,333

(22) Filed: Sep. 19, 2005

(30) Foreign Application Priority Data
Oct. 19, 2004 (KR) 10-2004-0083480

(51) Int. Cl. H04L 12/56

(52) U.S. Cl. 370/389; 370/401

(57) ABSTRACT

A channel navigation method of a digital broadcast and a digital broadcast receiver to be applied to the channel navigation method, select a program map table (PMT) using an identifier of an input source and a PMT packet identifier. A virtual channel table having a PMT packet identifier corresponding to the PMT, which provides a packet identifier of a transport stream packet including data for constituting each broadcast program, is received. The PMT is selected using the PMT packet identifier, and then the identifier of the transport stream packet is obtained from the PMT. If a specific program is selected, a packet having data for constituting the specific program is acquired using the identifier of the transport stream packet.

### CROSS-REFERENCE TO RELATED APPLICATIONS

This application claims priority from Korean Patent Application No. 10-2004-83480, filed on Oct. 19, 2004 in the Korean Intellectual Property Office, which is incorporated herein in its entirety by reference.

### BACKGROUND OF THE INVENTION

1. Field of the Invention

Methods and apparatuses consistent with the present invention relate to channel navigation of a digital broadcast and, more particularly, to channel navigation of a digital broadcast using a program map table (PMT) packet identifier inserted and transmitted in a virtual channel table (VCT).

2. Description of the Related Art

FIG. 1 is a flow chart for illustrating a conventional channel navigation method in a digital broadcast receiver.

With reference to FIG. 1, the conventional channel navigation method receives a program association table (PAT) packet through an antenna (S101). Here, the PAT specifies a PMT packet identifier that is an identifier of a packet for transmitting the PMT with respect to each broadcast program. Further, the PMT specifies an identifier of a transport stream (TS) for transmitting respective encoded signals constituting a broadcast program. As a result, the PMT is always referenced to extract data regarding program content.

Next, the PMT is selected using the received PAT packet (S103). Since the PAT provides a PMT packet identifier, the PMT is selected using the PMT packet identifier from the PAT.

Thereafter, when a user selects a program, an identifier of a packet having audio and video data for constituting the selected program is acquired from the PMT (S105). That is, the identifier of a packet having data of the selected program is obtained from the PMT, so that the packet having the data of the selected program is received using the identifier of the packet, and then audio and video data are displayed.

In accordance with such a channel navigation method of a digital broadcast, so as to extract data constituting content of a broadcast program, a PAT referencing a PMT corresponding to the broadcast program should be first received. Namely, a PMT packet identifier regarding the specific program is referred to in the received PAT, and the PMT is received using the PMT packet identifier. Consequently, in the conventional channel navigation method of a digital broadcast, the PAT is always received, and thereafter receipt of the PMT is performed using the received PAT, which results in a channel not being selected quickly.

### SUMMARY OF THE INVENTION

The present invention provides a channel navigation method of a digital broadcast and a digital broadcast receiver to be applied to the same, which select a PMT using a PMT packet identifier inserted in a VCT without using a PAT, and quickly select a desired channel in order to extract a program.

The above aspect of the present invention is substantially realized by providing a channel navigation method of a digital broadcast, and the method includes: receiving a VCT having a PMT packet identifier capable of selecting a PMT, the PMT providing a packet identifier (PID) of a transport stream (TS) packet including data constituting each broadcast program; selecting the PMT using the PMT packet identifier, and obtaining the packet identifier of the transport stream packet from the PMT; and when a specific program is selected, acquiring a packet having data constituting the selected specific program based on the packet identifier of the transport stream packet.

Preferably, but not necessarily, the PMT packet identifier may be selected based on an input source identifier of the TS packet.

Preferably, but not necessarily, the PMT packet identifier may be inserted in the VCT as a PMT packet identifier descriptor.

In accordance with another aspect of the present invention, there is provided a digital broadcast receiver including a receiving section which receives a transport stream (TS) packet having a VCT in which a PMT packet identifier is inserted; a PMT selector for selecting a PMT using the PMT packet identifier; and a controller for obtaining a packet identifier of a transport stream packet from the selected PMT, and acquiring a packet having data constituting a selected specific program based on the obtained packet identifier of the transport stream packet when the specific program is selected.

Preferably, but not necessarily, the PMT selector may select the PMT packet identifier based on an input source identifier of the TS packet, and then use the PMT packet identifier.

Preferably, but not necessarily, the receiving section may receive the PMT packet identifier inserted in the VCT as a PMT packet identifier descriptor.

### BRIEF DESCRIPTION OF THE DRAWINGS

The above and other aspects of the present invention will be more apparent by describing exemplary embodiments of the present invention with reference to the accompanying drawings, in which:

FIG. 1 is a flow chart for illustrating a conventional channel navigation method in a digital broadcast receiver;

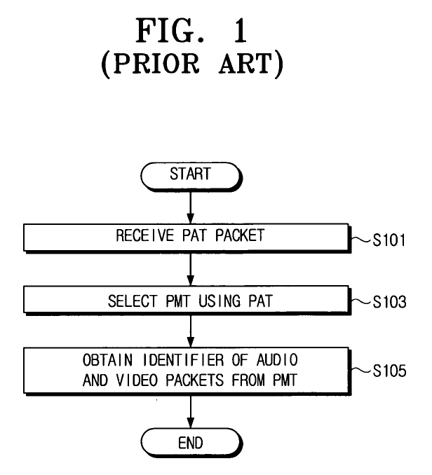

FIG. 2 is a block diagram showing a digital broadcast receiver to be applied to a channel navigation method in accordance with an exemplary embodiment of the present invention;

FIG. 3 is a flow chart that illustrates a channel navigation method in accordance with an exemplary embodiment of the present invention;

FIG. 4 is a detailed view for illustrating the channel navigation method in accordance with an exemplary embodiment of the present invention; and

FIG. 5 is a view showing a PMT packet identifier descriptor that is inserted in a VCT in a channel navigation method in accordance with an exemplary embodiment of the present invention.

### DETAILED DESCRIPTION OF THE EXEMPLARY EMBODIMENTS

The present invention will now be described with reference to the accompanying drawings, wherein like reference elements refer to similar elements, and in which exemplary embodiments of the invention are shown. The present invention, however, should not be construed as limited to the exemplary embodiments set forth herein. Rather, these exemplary embodiments are provided so that this disclosure will be thorough and complete, and will fully convey the scope of the invention to those skilled in the art.

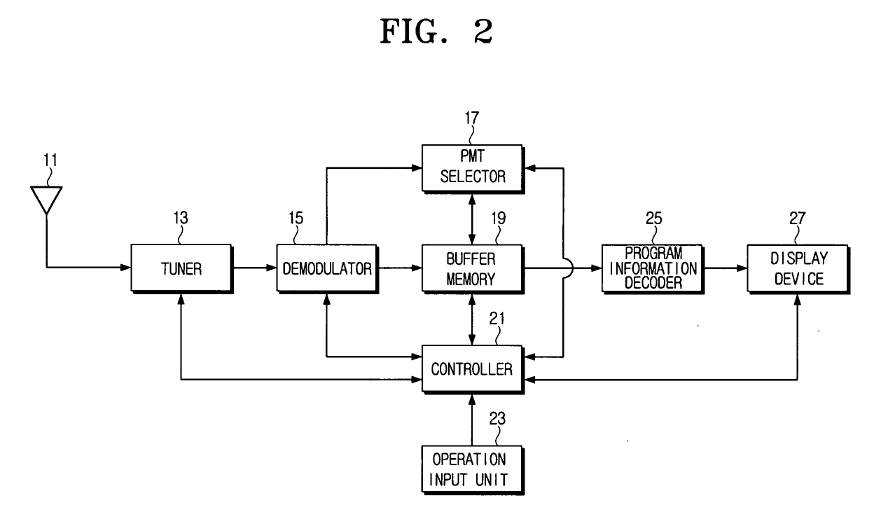

FIG. 2 is a block diagram showing a digital broadcast receiver to be applied to a channel navigation method in accordance with an exemplary embodiment of the present invention.

Referring to FIG. 2, the digital broadcast receiver receives a digital broadcast based on, for example, the Moving Picture Experts Group phase 2 (MPEG-2) system standard. The digital broadcast receiver comprises a tuner 13, a demodulator 15, a PMT selector 17, a buffer memory 19, a controller 21, an operation input unit 23, a program information decoder 25, and a display device 27.

The tuner 13 tunes and amplifies a signal received through an antenna 11, converts the amplified signal into an intermediate frequency, and transmits the intermediate frequency signal to the demodulator 15.

The demodulator 15 demodulates the intermediate frequency signal from the tuner 13.

The PMT selector 17 acquires a PMT PID corresponding to respective broadcast programs from the demodulated signal received from the demodulator 15, and separates a PMT packet based on the PMT PID. The separated PMT packet is stored in the buffer memory 19. Here, the PMT PID is information used for separating the PMT packet from a TS received through the antenna 11. The PMT PID is transmitted as a PMT PID descriptor that is inserted in a VCT.

The operation input unit 23 generates a signal to designate a desired broadcast program selected by a user.

The controller 21 reads the PMT packet separated by the PMT selector 17, and obtains an identifier of a packet having audio and video data for constituting a respective broadcast program. At this time, the PMT specifies an identifier of a TS transmitting each encoded signal for constituting the broadcast program. In order to extract data regarding content of the broadcast program, the controller 21 obtains an identifier of a packet having program data using the PMT stored in the buffer memory 19. The identifier of the packet is then stored in the buffer memory 19.

In addition, when the operation input unit 23 designates a broadcast program, the controller 21 reads an identifier of a packet having data for constituting the designated broadcast program from the buffer memory 19, and separates a packet corresponding to the read identifier.

The buffer memory 19 stores the PMT packet separated by the PMT selector 17. The buffer memory 19 also stores the identifier of a packet, having data for constituting the broadcast program, acquired from the PMT.

The program information decoder 25 decodes data of the packet, separated by the controller 21, having data for constituting the broadcast program. The data of the packet includes audio and video data.

The display device 27 displays audio and video data decoded by the program information decoder 25 on a screen.

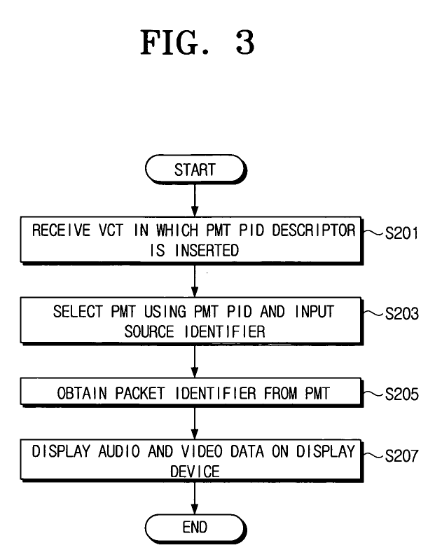

FIG. 3 is a flow chart that illustrates a channel navigation method in accordance with an exemplary embodiment of the present invention.

Referring to FIGS. 2 and 3, the tuner 13 receives a VCT in which a PMT PID descriptor is inserted (S201). Namely, the PMT PID is inserted in the VCT as a descriptor, and is then transmitted. By using a VCT in a TS being transmitted through the antenna 11, channel navigation information having an input source identifier and a PMT PID is constituted. Here, the PMT PID is data for searching a PMT that contains an identifier of a packet having data regarding a basic stream of each broadcast program.

Next, the PMT selector 17 selects a PMT using the PMT PID and the input source identifier (S203). The PMT selector 17 also acquires the PMT PID from an input signal using the input source identifier, and then selects the PMT having the acquired PMT PID. That is, the PMT selector 17 selects the PMT indicating one virtual channel of a digital television (DTV) using a PMT PID corresponding to information for searching the PMT.

Accordingly, the PMT selector 17 does not use a PAT providing a PMT PID that is an identifier of a packet having a program number (PN) and a PMT regarding a program in order to select the PMT. Instead, the PMT selector 17 selects the PMT using a PMT PID descriptor pmt_pid_descriptor, which indicates the PMT PID, inserted in the VCT. Based upon the PMT PID, the PMT is separated by the PMT selector 17 and is stored in the buffer memory 19.

Then, the controller 21 obtains an identifier of a packet having audio and video data of a corresponding program from the selected PMT (S205). The controller 21 separates the packet corresponding to the obtained identifier from the received TS by referring to the obtained identifier. At this time, when a user designates a program through the operation input unit 23, the controller 21 reads the packet of the PMT, which is separated by the PMT selector 17 and stored in the buffer memory 19, to obtain the identifier of a packet having data on the designated program. The identifier of the packet obtained in this manner is stored in the buffer memory 19. Thereafter, by using the obtained identifier of the packet, audio and video data constituting the program are acquired and displayed on the display device 27 (S207).

For example, the program information decoder 25 receives the packet, having data for constituting the audio and video data of the program, from the PMT and decodes the audio and video data. Then, the decoded audio and video data are displayed on the display device 27.

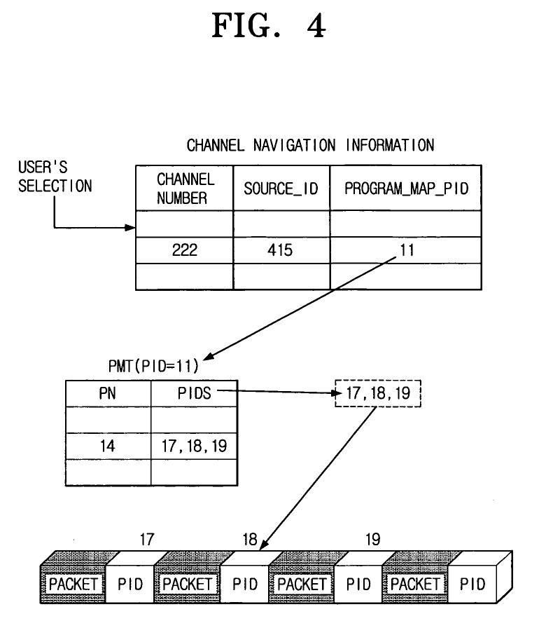

FIG. 4 is a detailed view for illustrating the channel navigation method in accordance with an exemplary embodiment of the present invention.

With reference to FIG. 4, channel navigation information includes a channel number, an identifier source_id of an input source, and a PMT PID program_map_pid. The channel navigation information is constituted using a VCT to be transmitted. Here, the identifier of an input source has a value unique among the channels, whereas a program number may have a value duplicated among the channels. Accordingly, the PMT PID is received using the identifier of the input source.

The PMT PID is data for searching a PMT that contains information regarding an identifier of a packet having data with respect to a basic stream of each program. The PMT PID is inserted into the VCT, and is then transmitted.

As shown in FIG. 4, when a user selects channel “222”, after a PMT PID is identified using the identifier source_id of the input source, a PMT is searched using the PMT PID. Namely, because an identifier of the input source regarding the channel “222” is “415”, a PMT PID of “11”, which corresponds to the identifier “415”, is selected.

In a PMT having a PMT PID of “11”, it is understood that identifiers of packets having data of a selected program are “17”, “18” and “19.” Consequently, data of packets having the identifiers of “17”, “18” and “19” are received, and then audio and video signals are displayed.

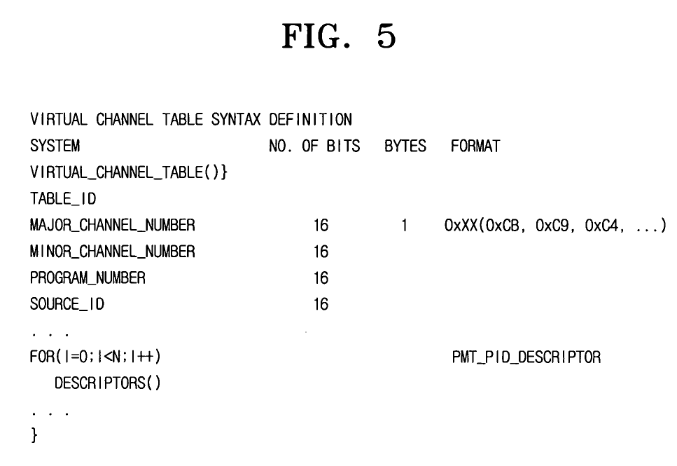

FIG. 5 is a view showing a PMT PID descriptor that is inserted in a VCT in a channel navigation method in accordance with an exemplary embodiment of the present invention. Namely, FIG. 5 shows a VCT syntax inserted into the VCT as a PMT PID.

As mentioned above, in accordance with the present invention, a PMT is selected using a PMT PID inserted into a VCT. Therefore, the present invention directly selects the PMT, and quickly receives audio and video data of a corresponding program without using a PAT.

The foregoing exemplary embodiments are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A channel navigation method of a digital broadcast, the method comprising:
receiving a virtual channel table (VCT) having a program map table (PMT) packet identifier identifying a PMT, which provides a packet identifier of a transport stream packet including data constituting a broadcast program;
selecting the PMT using the PMT packet identifier, and obtaining the at least one packet identifier of the transport stream packet from the PMT; and
if a specific broadcast program is selected, acquiring data constituting the specific broadcast program based on the packet identifier of the transport stream packet.

2. The method as claimed in claim 1, wherein the PMT packet identifier is selected based on an input source identifier of the TS packet.

3. The method as claimed in claim 1, wherein the PMT packet identifier is inserted in the VCT as a PMT packet identifier descriptor.

4. A digital broadcast receiver comprising:
a receiving section which receives a transport stream packet having a virtual channel table (VCT) in which a program map table (PMT) packet identifier is inserted;
a PMT selector which selects a PMT using the PMT packet identifier; and
a controller which obtains a packet identifier of a transport stream packet from the PMT which is selected by the PMT selector, and acquires data constituting a selected specific broadcast program based on the packet identifier of the transport stream packet if the specific broadcast program is selected.

5. The digital broadcast receiver as claimed in claim 4, wherein the PMT selector selects the PMT packet identifier based on an input source identifier of the TS packet, and then uses the PMT packet identifier to select the PMT.

6. The digital broadcast receiver as claimed in claim 4, wherein the receiving section receives the PMT packet identifier inserted in the VCT as a PMT packet identifier descriptor.
